(19) United States
(12) Patent Application Publication
(10) Pub. No.: US 2005/0148731 A1
(43) Pub. Date: Jul. 7, 2005

(54) Plastic materials with metal weight simulation

(75) Inventor: Carisa Chu, New Territories (HK)

Correspondence Address: WELSH & KATZ, LTD, 120 S RIVERSIDE PLAZA, 22ND FLOOR, CHICAGO, IL, 60606, US

(73) Assignee: Jing Mei Industrial Holdings Limited, Rarotonga (CK)

(21) Appl. No.: 10/750,276

(22) Filed: Dec. 31, 2003

(51) Int. Cl. C08L 67/02

(52) U.S. Cl. 525/165

(57) ABSTRACT

Improved water taps, showerheads, faucets and other plumbing supplies and fixtures can be effectively molded with plastic materials with metal weight simulation. Preferably, the plastic materials comprise polybutylene terephalate (PBT) and acrylonitrile butadiene styrene (ABS).

### BACKGROUND OF THE INVENTION

This invention relates to plumbing supplies and fixtures and, more particularly, to water taps, showerheads and other products made of plastic materials simulating the appearance of metal.

There are numerous plumbing supplies and fixtures for use in homes, offices, factories, restaurants, public facilities and other places. Such plumbing supplies and fixtures include water taps, showerheads, faucets, valves, handles, etc. In the past, plumbing supplies and fixtures have been made of metal, such as stainless steel, cooper, brass, zinc, aluminum, chrome plated iron, etc. In order to reduce the cost and weight of such plumbing supplies and fixtures, attempts have been made to mold such plumbing supplies and fixtures out of plastic. This has met with varying decrees of success. Generally, customers have been reluctant to accept plastic molded plumbing supplies and fixtures unless it simulates the appearance of metal.

Friedrich Grobe AG of Hemer, Germany has developed a new lever for water tabs that uses a combination of acrylonitrile butadiene styrene (ABS) and glass-reinforced nylon. More particularly, an injection molded tap lever using ABS on the outside has been manufactured to provide a chrome-plated finish resembling more expensive die-cast and plated zinc. Because the manufacturer believed that ABS alone does not have sufficient flexural strength to prevent flexing and cracking of the chrome-plating, the ABS was molded over a core of 60% glass-reinforced nylon as a mechanical support. The core resin was Grivory GV-6H brand resin, a partially aromatic nylon available from EMS-Chemie of Switzerland.

The use of nylon however, either alone or in combination with ABS, creates difficulties and problems for water plumbing supplies. Because nylon is very sensitive to humidity change, the moisture level has to be kept in a very narrow range and defects may occur as a result of:
(a) cracking;
(b) loss or distortion of mechanical properties, such strength, compression, tension and/or torsion; and
(c) dimensional derivation as a result of expansion or reduction of the size of the nylon component causing unacceptable deviations in the length, width and height of the device.

Furthermore, if nylon is used in water plumbing devices, the nylon should be completely sealed off from moisture which increases the expense, time, and complexity of the design process. Moreover, nylon should be kept at a certain moisture level before and after the injection molding stage. Typically, this requires the nylon to be placed in a delicate dryer twice so as to maintain its moisture level. Such procedures create:
(d) longer processing times;
(e) higher manufacturing costs; and
(f) additional process steps.

It is, therefore, desirably to provide improved plumbing supplies which overcome the preceding problems.

### BRIEF SUMMARY OF THE INVENTION

Improved plastic materials with metal weight simulation are provided for use in plumbing supplies and other products. Advantageously, the improved composition, plumbing supplies and products are attractive, economical, reliable, and effective. Desirably, the user friendly plastic materials, plumbing supplies and products are easy to mold, simple to install, and sturdy.

The structural strength and integrity of the novel plastic materials, composition, plumbing supplies and products avoid the numerous deficiencies and defects of nylon plumbing supplies and products by eliminating or minimizing:
(a) cracking;
(b) loss or restoration of mechanical properties, such as strength, compression, tension, and/or torsion; and
(c) dimensional derivation which can cause unacceptable deviations in the dimensions and tolerances of the plumbing supplies and products.

The novel plastic materials, composition, plumbing supplies and products are able to be molded more efficiently than nylon plumbing supplies and products, resulting in;
(d) shorter processing time;
(e) lower manufacturing costs; and
(f) fewer intermediate steps.

In a preferred form, a composition for simulating metal (metal weight simulation) is provided for use in plumbing supplies and other products. Advantageously, the novel composition comprises: polybutylene terephalate (PBT) and acrylonitrile butadiene styrene (ABS). The total overall weight of the novel composition can be from about 5% to about 10% lighter than metal used in corresponding plumbing supplies or other products. Reduction in weight is useful to decrease transportation costs as well as to reduce the overall weight of vehicles, airplanes and boats. The preferred ratio of PBT to ABS ranges from about 1:3 to about 1:10. For best results, the ratio of PBT to ABS is about 1:8.

A more detailed explanation of the invention is provided in the following description and appended claims taken in conjunction with the accompanying drawings.

### BRIEF DESCRITPION OF THE DRAWINGS

FIG. 1 is a perspective view of a lever of a water tap, faucet and hand valves (handles) in accordance with principles of the present invention;

FIG. 2 is a perspective view of another faucet and hand valves (handles) in accordance with principles of the present invention; and

FIG. 3 is a perspective view of a showerhead and a another hand valve (handle) in accordance with principles of the present invention.

### DETAILED DESCRIPTION OF THE INVENTION

A detailed description of the preferred embodiments and best modes for practicing the invention and producing plastic materials with metal weight simulation, composition, plumbing supplies and other products are described herein.

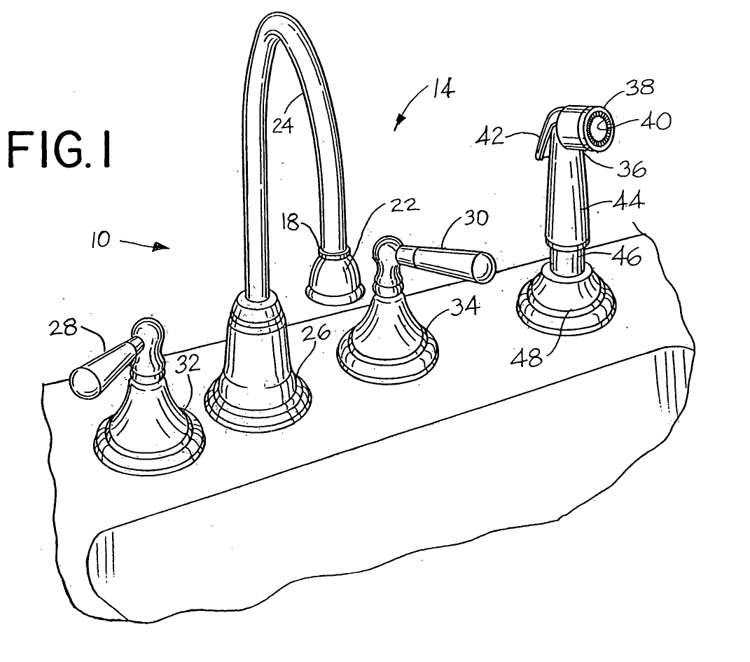

Simulated metal plumbing supplies 10-12 (FIGS. 1-3) comprise plastic materials with metal weight simulation. The plumbing supplies can includes plumbing fixtures 14-16 (FIGS. 1-3), comprising a long neck faucet 18 (FIG. 1) that provides a spigot or spout with a rounded converging convex head 22 and a U-shaped elongated neck 24 which provides a conduit connecting the head 22 to a bell-shaped base 26. Hot and cold water hand valves 28 and 30 provide single lever manually grippable handles to turn on and off the water to the water tap. The handles can be mounted on bell-shaped bases 32 and 34. A spray nozzle 36 can have a spray head 38 with a set, array, series or circular pattern of apertures (holes) 40. The spray nozzle can have a rearward downwardly extending lever 42 that provides a on-off valve to control the flow of water to the apertures of the spray head. The spray head can be connected to an elongated rounded diverging body 44 and can have a reduced diameter bottom 46 that can be detachably seated and mounted on a bell-shaped base 48.

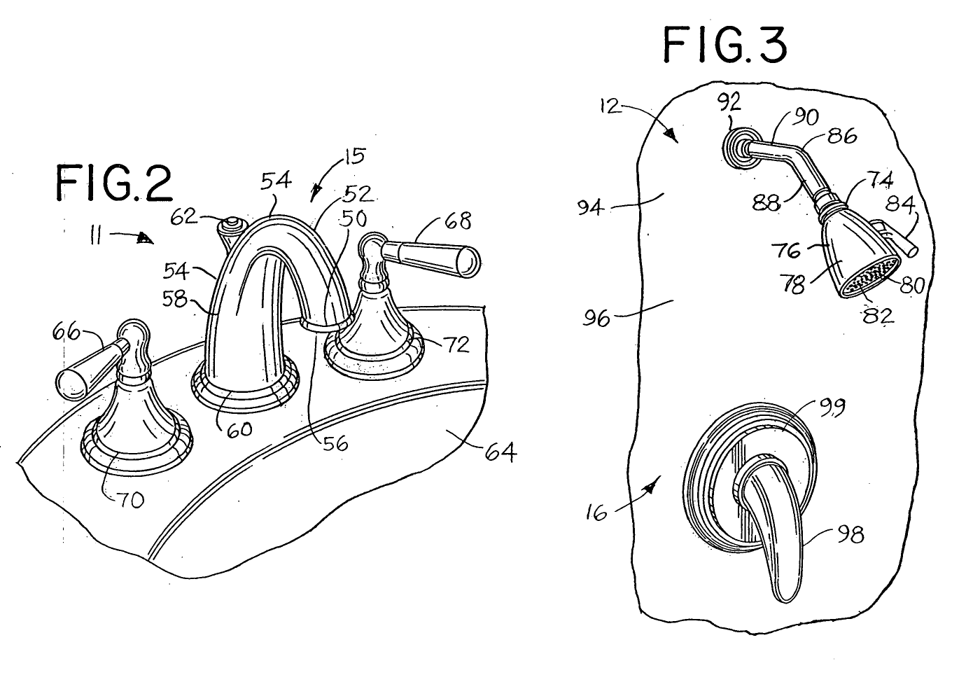

The plumbing supplies 11 (FIG. 2) and plumbing fixtures 15 can also include a water tap 50 comprising a short neck faucet 52 that provides a spigot or spout. The short neck faucet can have a rounded C-shaped or hook-shaped neck 54 with a discharge outlet (opening) 56 and an enlarged diameter bottom portion 58 mounted on a base 60. A rearward upright reciprocable pull-push drain knob 62 can be provided to control the accumulation and discharge of water in a sink 64. Hot and cold water hand valves 66 and 68 can provide single lever manually grippable handles to turn on and off the water to the short neck nozzle of the water tap. The handles can be mounted on bell-shaped bases 70 and 72.

The plumbing supplies 12 (FIG. 3) and plumbing fixtures 16 can further include a water tap 74 comprising a showerhead 76. The showerhead can have a diverging portion 78 with a spray face 80 with a set, series, array or circular pattern of port holes 82 that provide spray outlets or apertures to emit a shower spray. The position of the spray head or spray pattern can be manually adjusted by a control lever 84. The spray head can be connected to a pipe (conduit) 86 through bent pipe section 88 and 90. The pipe can be mounted on a base 92 on the wall 94 of a shower 94 of a shower 96. A single lever, pivotable, rounded, curved, manually grippable handle 98 can be provided to control the flow of hot and cold water to the showerhead. The handle can be positioned below the showerhead and mounted on an enlarged circular base 99 secured to the wall of the shower.

The levers, handles and knobs described about provide examples of various water control devices. Other water control devices can be used with the composition described herein to provide plastic materials with metal weight simulation.

The simulated metal plumbing supplies comprise: polybutylene terephalate (PBT) and acrylonitrile butadiene styrene (ABS). Desirably, the total overall weight of the simulated metal plumbing supplies are from about 5% to 10% lighter than corresponding plumbing supplies consisting of actual non-simulated metal. The preferred ratio of PBT to ABS in the plumbing supplies range from about 1:3 to about 1:10. Most preferably, the ratio of PBT to ABS is 1:1.9 to about 1:8.2.

The weight and ratio of PBT to ABS should meet the design and functional requirements of the plumbing supplies. For example, if a faucet is to heavy, it may shut down the water supply by its own natural weight, thereby hindering the normal operation of the faucet. Therefore, usually the weight of the component or product adopting the inventive composition is adjusted to be about 5% to about 10% lighter than the same device using metal.

The preceding composition, plumbing supplies and products use plastic material to produce components that simulate the appearance and weight of metals to meet consumer demands. The mechanical properties satisfy the basic requirements and the finish is good to give a metallic finishing or other desired surface finishing, often regardless of any secondary operation.

The PBT is compatible with ABS during the injection molding process so there can be a beneficially chemical reaction between the two material interfaces. The specific gravity of the composition and PBT is preferably greater than 2.25. The PBT provides mechanical properties which can be even better than ABS. The combination of PBT and ABS provides surprising good results which are better than the use of PBT or ABS alone, as well as better than nylon molded products.

Injection molded grade PBT and ABS can be efficiently and easily processed with minimum investment or the need for special equipment. Furthermore, the surface finishing process is able to perform without additional equipment investment.

The processing methods can include the steps of building a steel tool according to the part design. The tool building method (process) can be similar to other tools. Thereafter, a plastic molding process, such as injection molding can be performed to mold the plastic materials into the designated appearance, shape and product form. Secondary operations can be preformed as necessary.

The following is an example of plastic materials with metal weight for composite plumbing supplies of the invention. It should be clearly understood, however, that this example is given solely by way of illustration of the composition and products of the subject invention and shall not be regarded as restricting the scope of the invention, as defined by the accompanying claims.

### EXAMPLE

A lever (handle) for a water tap was molded by an injection molding process. During the injection molding process, both PBT and ABS were simultaneously injected into the mold and cured. The ratio of PBT to ABS was 1:8. The resultant composite lever was curved with an overall length of about 6.5 inches (165.1 mm), a maximum diameter of about 1⅞ (1.875) inches (47.625 mm), a wall thickness of about 3/32 (0.0938) inches (2.3835 mm), and a smaller tapered end having a width of about 1 inch (25.4 mm). The resultant composite lever weighed about 6.3 ounces (178.6 g).

Among the many advantages of the plastic materials with metal weight simulation, composition, plumbing supplies and products of the invention are:

1. Outstanding performance.

2. Superb composites, plumbing supplies and products.

3. Attractive to consumers.

4. Easy to mold and fabricate.

5. Convenient products which are simple to use and install.

6. Excellent value.

7. Avoids absorbing water as nylon molded products.

8. Part designs are very flexible.

9. Various part weights are adjustable by using different kinds or volumes of plastic materials. This helps to compensate the disadvantages of metals which can be heavy, costly or difficult to fabricate and which may adversely effect the functionality of the final products. Using different plastic materials, namely, PBT and ABS, provides a wide range of weight for the finished products that can be obtained without changing the original part design.

10. Usually, no need to brush the part or product after molding and before the secondary operation as required for corresponding metal parts.

11. Lower processing costs.

12. Surface finishing is easy to process via one or more secondary operations on the finished part surface.

13. The inventive metal weight simulation, composition, plumbing supplies and products comply with the test requirements of the Canadian Standards Association (CSA) and the Copper-Accelerated Acetic Acid-Salt Spray Testing (CASS).

14. Dependable.

15. Safe.

16. Economical.

17. Efficient.

18. Effective.

In some circumstances, it may be desirable to use acrylonitrile ethylene styrene (AES) or acrylonitrile butadiene acrylete (ABA) in combination with or in lieu of ABS.

Although embodiments of this invention have been shown and described, it is to be understood that various modifications, substitutions, and rearrangements of parts, components, equipment, compounds, and process (method) steps, as well as other additional compounds and other examples of the improved plastic materials with metal weight simulation and composite plumbing supplies, and other sizes, shapes, weights, and compositions of the products, as well as other types of products, can be made by those skilled in the art without departing from the novel spirit and scope of this invention.

1. A composition for simulating metal for use in plumbing supplier and other products, comprising:
polybutylene terephalate (PBT); and
acrylonitrile butadiene styrene (ABS).

2. A composition as in claim 1 having a total overall weight from about 5% to about 10% lighter than corresponding metal plumbing supplies and metal products.

3. A composition as in claim 1 wherein the ratio of PBT to ABS ranges from about 1:3 to about 1:10.

4. A composition as in claim 1 wherein the ratio of PBT to ABS is about 1:8.

5. Simulated metal plumbing supplies, comprising:
polybutylene terephalate (PBT); and
acrylonitrile butadiene styrene (ABS).

6. Simulated metal plumbing supplies as in claim 5 comprising plumbing fixtures.

7. Simulated metal plumbing supplies as in claim 5 comprising a water tap.

8. Simulated metal plumbing supplies as in claim 5 comprising a showerhead.

9. Simulated metal plumbing supplies as in claim 5 comprising a faucet.

10. Simulated metal plumbing supplies as in claim 5 comprising a valve including a water control device selected from the group consisting of a manually grippable handle, knob, and lever.

11. Simulated metal plumbing supplies as in claim 5 having a total overall weight from about 5% to about 10% lighter than corresponding plumbing supplies consisting of actual (non-simulated) metal.

12. Simulated metal plumbing supplies as in claim 5 wherein the ratio of PBT to ABS ranges from about 1:3 to about 1:10.

13. Simulated metal plumbing supplies as in claim 5 wherein the ratio of PBT to ABS is 1:1.9 to about 1:8.2.
